(19) United States
(12) Patent Application Publication
(10) Pub. No.: US 2014/0273700 A1
(43) Pub. Date: Sep. 18, 2014

(54) COMPOSITE MATERIAL WITH IMPROVED MOISTURE DRAINAGE

(71) Applicant: SYMPATEX TECHNOLOGIES GmbH, Unterfoehring (DE)

(72) Inventors: Mhamed Mouhassin, Munchen (DE); Liviu-Mihai Pavelescu, Munchen (DE)

(21) Appl. No.: 14/349,587

(22) PCT Filed: Oct. 2, 2012
(86) PCT No.: PCT/EP2012/069416

§ 371 Date: Apr. 3, 2014

(30) Foreign Application Priority Data
Oct. 5, 2011 (EP) 11183965.0

(51) Int. Cl. B32B 5/26; A47C 31/11

(52) U.S. Cl. CPC B32B 5/26; A47C 31/11
USPC 442/319; 428/316.6

(57) ABSTRACT

A composite material for application in a shoe upper, sole or seat cover, including a waterproof, water vapour-permeable functional layer as well as an air-permeable dual-layer composite, wherein the dual-layer composite is constructed so that the layer of the dual-layer composite facing the functional layer has a higher hydrophilicity and absorptivity than the layer of the dual-layer composite facing away from the functional layer.

The present invention relates to a composite material with improved moisture drainage, for example for application in a seat cover or seat fabric or in a shoe upper.

### BACKGROUND

Composite materials for application in shoes, seat covers or in items of clothing are known. EP 0 857 433 B1, for example, describes a shoe with an outer layer and a ventilation layer within this outer layer, which has at least one textile fabric on the side facing the interior of the shoe, which is kept separate from the outer layer using spacers.

DE 44 19 801 A1 describes an item of clothing and an item of footwear each with an outer layer and a composite material. The composite material contains a waterproof, water vapour-permeable functional layer, wherein an air-permeable knitted fabric layer is arranged on one side of the functional layer. The outer layer can be at least one representative from the group comprising a leather layer, textile layer, textile-like layer and woven fabric. Possible options for the outer layer as upper material are canvas, chintz, everglaze, terry cloth, velvet, Manchester corduroy, corduroy, velveteen, Norzon, chamois, leather velvet, duvetyne, knitted fabrics, satin, fur, imitation fur, raw/smooth/patent leather or buffed, embossed, shrunken or imitation leather. The outer layer is only arranged on the composite material, wherein the outer layer can be arranged on the side of the functional layer facing away from the knitted fabric layer or on the side of the knitted fabric layer facing away from the functional layer.

WO2010/149680 discloses an exterior material for a shoe made of three to four layers, namely in the direction from outside to inside:

A ventilation layer serving as an outer layer, under which a water vapour-permeable membrane, under which a knitted fabric made of a multifilament or monofilament yarn and optionally under that a lining, which can consist of a hydrophilic or hydrophobic material, wherein the ventilation layer and the knitted fabric layer are both laminated with the water vapour-permeable membrane.

A construction of this type already offers very high breathability but there is need for improvement with regards to the outwards moisture transport.

WO1998/051177 discloses in FIG. 3bis a composite material for a shoe, which comprises a water vapour-permeable membrane 215a, on which a layer 222c made of a hydrophilic material is located. A so-called “filling layer” 222a—for example, made of felt—that is either water vapour permeable or perforated is arranged on top of the hydrophilic layer 222c. Lastly another layer 222b made of a hydrophobic material is located on the filling layer 222a of WO1998/051177.

The hydrophobic layer 222b is designed to propel moisture in the direction of the hydrophilic layer 222c and thus in the direction of membrane 215a.

The structure proposed in WO1998/051177 admittedly results in more effective moisture drainage, but in regards to efficiency it leaves something to be desired.

### BRIEF SUMMARY

The present invention therefore proposes an improved composite material for application in a shoe upper or seat cover.

The invention relates to a composite material, which comprises a waterproof, water vapour-permeable functional layer as well as an air-permeable dual-layer composite, which is characterised in that the dual-layer composite is constructed so that the layer of the dual-layer composite facing the functional layer has a higher hydrophilicity and absorptivity than the layer of the dual-layer composite facing away from the functional layer.

The core of the invention thus consists of a hydrophilicity and absorptivity gradient, wherein the hydrophilicity and absorptivity successively increase in the direction of the membrane. It is therefore not at all critical if materials are used for the individual layers that one would generally characterise as rather hydrophobic, so long as the hydrophobic effect decreases from layer to layer in the direction of the membrane and consequently the hydrophilicity increases in the same direction.

By using the composite material according to the present invention a directional moisture transport is created, which also works against gravity (e.g. in specific areas of the shoe upper).

By contrast WO1998/051177 instead proposes an upper hydrophobic layer 222b and a hydrophilic layer 222c adjacent to the membrane; however a fill layer 222a is located between these layers, which is only perforated or water vapour permeable. By using the structure of the layers proposed in WO1998/051177 there is a transport of moisture in the form of water vapour, not however of water, because the layer 222b designed to be hydrophobic repels the water. Because this hydrophobic layer is located at the top, it is therefore adjacent to the foot. A waterrepellent layer is arranged at the place in which the most moisture in the form of water can be formed. Consequently in the place in the shoe in which the highest occurrence of sweat is to be expected, very low removal of liquid is achieved. WO 1998/051177 therefore provides perforations to transport the water away from the foot through the layers. A—passive—transport of this type can however essentially only take place in the direction of gravity—that is, downwards. In addition this transport must be supported by the exertion of pressure by the movement of the foot. Transporting liquid against gravity is therefore not possible.

### BRIEF DESCRIPTION OF THE DRAWINGS

FIG. 1 schematically shows a structure that represents the composite material described herein in a preferred layer structure, as used, for example, in a seat cover.

FIG. 2 schematically shows a structure that represents the composite material described herein in a preferred layer structure, as used, for example, in a shoe.

FIG. 3 schematically shows that the moisture or water vapor transport can take place, for example, against the direction of gravity.

FIG. 4 shows how the different layers, in particular, absorbent layer 15, quickly absorbs the water in a capillary action and widely distributes it.

FIG. 5 shows how the different layers, in particular, absorbent layer 15, quickly absorbs the water in a capillary action and widely distributes it.

### DETAILED DESCRIPTION

The present invention solves the problem by the introduction of a hydrophilicity and absorptivity gradient, which enables effective transport of liquid (water) and water vapour in all directions, in particular also upwards, which is particularly favourable when used in a shoe upper, for example.

A further subject matter of the invention relates to an item of clothing, a headpiece, gloves and an item of footwear with an outer layer, which is characterised in that at least one part of the same is lined with the composite material according to the invention.

A further subject matter of the invention relates to a seat fabric, for example for a car seat, which contains the composite material according to the invention.

The prior art provides one skilled in the art with the knowledge that using a knitted fabric or a woven spacer fabric and the functional layer should be sufficient, together with the pumping effect created by the motion of the foot, for achieving sufficient ventilation and simultaneous redirection of the moisture out of the shoe interior via the functional layer to the outer material.

It has been determined, however, that these conditions are not sufficient for quickly draining moisture from all areas of the shoe interior, which manifests itself in the creation of moisture traps.

Furthermore the prior art does not satisfactorily ensure that the liquid, once drained in the direction of the membrane, is not returned.

Due to the increasing hydrophilicity and absorptivity of the two layers of the dual-layer composite in the direction of the functional layer, there is a preferred direction for moisture transport, effectively a “one-way street effect”. The moisture is quickly and efficiently transported in the direction of the functional layer and discharged through it in the form of water vapour.

The trick is in the fact that the layer located on the side of the dual-layer composite facing away from the functional layer works as a barrier layer for moisture, whereas the layer of the dual-layer composite facing the functional layer works as an absorbent layer. Due to the higher hydrophilicity and absorptivity of the latter layer, the moisture is absorbed in the direction of the functional layer and does not return because of the lower hydrophilicity and absorptivity of the barrier layer.

The absorbent layer has two functions:
1- It quickly passes moisture on to the membrane.
2- It distributes the moisture widely: the absorbed moisture is passed on horizontally, wherein the absorptive effect is determined according to the test method in DIN 53924 [Velocity of soaking water of textile fabrics (method by determining the rising height)]. As a result the membrane is quickly activated over a wide area, and thus optimal water vapour transport characteristics are achieved.

This double layer of barrier and absorbent layers, controlled only by the hydrophilicity difference or gradient and the difference in absorptivity, is significantly more effective than the use of a knitted fabric or woven spacer fabric, as described in the prior art.

The desired hydrophilicity and absorptivity gradient can basically be achieved in different ways. In addition to the use of different materials or material combinations with inherently different hydrophilicity, e.g. polyester/polyamide or polypropylene/polyamide, the gradient can also be set so that the fibres of the layer composite have a different fineness and/or that large-capillary layers exist in addition to fine-capillary layers. Furthermore the finishing procedures known in the art are suitable for changing the hydrophilicity/hydrophobia of textile materials to set the desired gradient.

In a preferred embodiment the air-permeable double layer contains at least one non-woven layer; more preferably both layers of the air-permeable double layer consist of non-woven layers, which are differentiated by their increasing hydrophilicity in the direction of the functional layer. This means the layer of the double layer facing the functional layer can be, for example, a non-woven polyamide and the layer of the double layer facing away from the functional layer a non-woven polyester. The double layer can consist of the same or different materials (e.g. polyester or polyamide). Insofar as both layers of the double layer consist of the same materials, these materials are differentiated for example in their fineness and/or their capillary action.

In a particular embodiment the dual-layer composite of the composite material according to the invention is constructed so that the layer of the dual-layer composite facing the functional layer is formed by a non-woven fabric of finer fibres (e.g. nanofibres, microfibres or standard fibres) and the opposite layer of the dual-layer composite is formed by a non-woven fabric with coarser fibres, in comparison to the layer facing the functional layer.

In this way the efficient and rapid transport of moisture in the direction of the functional layer is achieved in a simple and elegant manner.

Further preferred is a composite material that is characterised in that the dual-layer composite contains polyester as one of its materials and is constructed so that the layer of the dual-layer composite facing the functional layer is formed by a non-woven fabric with a lower proportion of polyester and the opposite layer of the dual-layer composite is formed by a non-woven fabric with a higher proportion of polyester.

Particularly preferably the dual-layer composite contains polyamide as an additional material. The proportion of the materials of polyester and polyamide in the layers of the dual-layer composite can lie between 0 and 100%, depending on the desired hydrophilicity.

As the functional layer, particularly suitable materials are those that are waterproof and water vapour permeable. For this purpose, functional layers that have a film or membrane of, for example, expanded polytetrafluoroethylene (ePTFE) (Gore-Tex), polyester, polyether ester, polyether urethane, polyether amide and/or polyurethane are preferred. The membrane made of polytetrafluoroethylene can be microporous and preferably coated with hydrophilic polyurethane or other polymers. In a further embodiment the membrane made of polyether ester and/or polyester can be not porous but rather homogeneous, wherein preferably hydrophilic polyester or hydrophilic polyether ester is used. This membrane (SympaTex membrane) advantageously has a thickness of, for example, 10 μm or 15 μm and a density of 1.27 g/cm³. It is characterised by, among others, excellent water tightness and water vapour permeability of over 2700 g/m² in 24 h.

Particularly preferred is a functional layer with the homogeneous polyether ester membrane, because it has not only excellent vapour permeability characteristics but also offers excellent protection against cold particularly when used in winter shoes. In addition the unpleasant damp feeling caused by sweat moisture is greatly reduced by using the homogeneous, hydrophilic membrane as the functional layer.

In an advantageous embodiment of the subject matter of invention the functional layer contains a waterproof, water vapour-permeable material, wherein the waterproof, water vapour-permeable material can be a film made of expanded polytetrafluoroethylene, a membrane made of polyether ester, polyether urethane or polyether amide, a polyester membrane and/or a microporous, preferably polyurethane coating. The polyether ester membrane or polyester membrane can be homogeneous.

The homogeneous membrane also expands the spectrum of use for the composite according to the invention to the industrial chemical area, due to its unique characteristic, namely that skin-irritating, wetting or caustic liquids cannot penetrate it. The use of the composite material according to the invention in shoes and items of work clothing for chemical areas fully protects the user against acids and bases without the user needing to fear the danger of excessive sweating during his or her work.

Furthermore a composite material with a functional layer made of the abovementioned membrane is also suitable because the membrane has an ultimate elongation of approx. 300%.

Of course, the composite material according to the invention can also be combined with other layers that are conventional per se.

In a further preferred embodiment the composite material according to the invention is characterised in that the side of the functional layer facing away from the dual-layer composite is adjacent to a knitted fabric layer or 2-dimensional warp knit.

A knitted fabric layer of this type is easily manufactured by conventional manufacturing procedures, because the spacer structure contains stitches joining the spacer fabrics with, preferably monofilament, elastic or flexible threads, which can be alternately joined to or interconnected with one knitted fabric in each case. Furthermore the monofilaments forming the stitches joining the fabrics are preferably to be used as spacers.

In a further preferred embodiment of the composite material according to the invention, the functional layer can be bonded to the knitted fabric layer, preferably point-wise, grid-wise and/or strip-wise.

In an especially preferred embodiment the textile 2-dimensional warp knit can be warp knit fabric or Raschel fabric, wherein the warp knit fabric is double sided. The knitted fabrics can have spacer strips or webs. It is also possible to manufacture the spacer structure and/or the knitted fabrics with a right—right or right—left knitted structure. Because the spacer structure can be a woven, knitted or non-woven layer, the manufacturing methods of the same are not dependent on specific fibres because of the suitability of all possible yarns, such as natural fibres and/or synthetic fibres—multifilament or monofilament. Accordingly the costs are low. The costs for manufacturing a product with this composite material, e.g. footwear, items of clothing, gloves, headpieces, are also correspondingly low.

In yet a further preferred embodiment the composite material according to the invention is characterised in that the side of the functional layer facing away from the dual-layer composite is adjacent to an outer layer. This outer layer can be at least one representative from the group comprising a leather layer, textile layer, textile-like layer and woven fabric. Possible options for the outer layer as upper material are canvas, chintz, everglaze, terry cloth, velvet, Manchester corduroy, corduroy, velveteen, Norzon, chamois, leather velvet, duvetyne, knitted fabrics, satin, fur, imitation fur, raw/smooth/patent leather or buffed, embossed, shrunken or imitation leather.

Likewise, the composite material according to the invention can be used in an item of clothing with an outer layer, in which at least one part of the item of clothing is lined with the composite material on the inside of the outer layer. It is also possible to manufacture a headpiece with an outer layer, wherein at least one part of the headpiece is lined with the composite material according to the invention on the inside of the outer layer. Likewise a glove can be furnished with an outer layer and the composite material according to the invention, characterised in that at least one part of the glove is furnished with the composite material according to the invention on the inside of the outer layer.

In a particular embodiment footwear can be constructed with an outer layer and the composite material so that at least one part of the shoe is lined with the composite material according to the invention on the inside of the outer layer.

In a further preferred embodiment, the composite material is characterised in that the side of the dual-layer composite facing away from the functional layer is adjacent to a lining or lining layer.

This type of lining layer is known, wherein the lining layer can be a terry cloth layer, goat/sheep/cow/pigskin leather lining, velvet lining, camel hair lining, knitted or woven fur layer or a knitted or woven fabric layer advantageously made of cotton, new wool, synthetic fibres and/or regenerated and/or modified cellulose.

It is especially preferred if the lining is hydrophilic. Even more preferred is that the hydrophilicity increases from the lining via the air-permeable dual-layer composite in the direction of the functional layer. In this way an effective absorptive effect and good moisture transport are ensured in the direction of the functional layer.

The lining layers that have an open mesh or perforated structure can have a hydrophobic finish; thus the moisture can easily and quickly penetrate through the holes to the barrier layer or the absorbent layer.

Other features, aspects and advantages of the present invention are to be taken from the following description of two preferred embodiments using the schematic FIGS. 1 and 2. The same numbers within the figures indicate identical components.

FIG. 1 schematically shows a structure that represents the composite material according to the invention in a preferred layer structure, as it is used in, for example, a seat cover.

Arrow 1 shows the direction of the increase of hydrophilicity through the layer structure. Arrows 2 and 4 detail the flow direction of moisture or water vapour within the layer structure. The moisture or water vapour 3 itself is represented as small circles. Layer 40 represents the outer material of the seat, e.g. leather. The air-permeable dual-layer composite, consisting of layer 10 (also designated as the barrier layer) and layer 15 with higher hydrophilicity (also designated as the active, highly absorbent layer), is adjacent to layer 20 (the functional layer or membrane). A 2-dimensional warp knit, layer 50, is located on top of the membrane. It can be seen from the angled arrows 4 that barrier layer 10 ensures that the moisture or water vapour 3 cannot—or at least not substantially—flow back. A hydrophilicity and absorptivity gradient is formed across the layer structure.

FIG. 2 schematically shows a structure that represents the composite material according to the invention in a preferred layer structure, as it is used in, for example, a shoe.

Arrow 1 shows the direction of the increase of hydrophilicity through the layer structure. Arrows 2 and 4 detail the flow direction of moisture or water vapour within the layer structure. The moisture or water vapour 3 itself is represented as small circles. Layer 5 represents the lining of the shoe, e.g. a polyester or polyamide knitted fabric or a non-woven polyester. The air-permeable dual-layer composite, consisting of layer 10 (also designated as the barrier layer) and layer 15 with higher hydrophilicity (also designated as the active, highly absorbent layer), is adjacent to layer 20 (the functional layer or membrane). An outer layer, as layer 30, is located on top of the membrane, e.g. a knitted fabric, woven fabric, non-woven fabric or leather. It can be seen from the angled arrows 4 that barrier layer 10 ensures that the moisture or water vapour 3 cannot—or at least not substantially—flow back. A hydrophilicity and absorptivity gradient is formed across the layer structure.

In both embodiments the cooperation between barrier layer 10, the highly absorbent layer 15 and the membrane 20 is crucial. In particular, due to the fact that the absorbent layer 15 has a higher hydrophilicity than the barrier layer, an acceleration of the removal of moisture results in the direction of the functional layer (membrane) 20. The active, highly absorbent layer therefore ensures that the moisture only moves in the direction of the membrane, and the moisture or sweat is widely distributed and passed on to the membrane. The membrane is strongly activated by the moisture delivery. The more damp the membrane is, the more breathable it is.

FIG. 3 schematically shows that the moisture or water vapour transport—as distinct from the prior art—can also take place against the direction of gravity. For example, the sequence from bottom to top of lining 5, hydrophilic barrier layer 10, active, highly absorbent layer 15, membrane 20 and knitted fabric 30 shows how the removal of moisture takes place from the bottom up.

FIG. 4 and FIG. 5 show how the different layers, and in particular absorbent layer 15, quickly absorb the water in a capillary action and widely distribute it.

In FIGS. 4 and 5 the layers are the same as those in the description of FIG. 1 and FIG. 2, that is from left to right: 40 (outer material of a seat) or 5 (lining of a shoe), 10 (barrier layer), 15 (active, highly absorbent layer); 20 (functional layer or membrane); 50 (2-dimensional warp knit in a seat) and 30 (outer layer of a shoe).

### EXAMPLE

A composite material according to the invention is provided comprising a lining (5) made of a knitted fabric with a composition of 83% polyamide/17% polyester (available, for example, from Wilhelm Textil, Pirmasens, Germany). Further, the composite material contains a non-woven material (available, for example, from Hassan, Turkey) as a double layer made of a hydrophilic barrier layer (10) and absorbent layer (15), wherein the area of the hydrophilic barrier layer (10) consists 100% of polyester and the absorbent layer (15) is made of 80% polyester/20% polyamide. A polyether ester membrane from SympaTex, Unterföhring (Germany), serves as a functional layer (20). A knitted fabric made of 100% polyester (available, for example, from Matthes & Ammann, Meβstetten-Tieringen, Germany) as the outer layer (30) is located on the other side of the functional layer (20).

The table shows the rising heights of the individual layers for the above-mentioned composite material—measured based on DIN 53924—consisting of lining 5, hydrophilic barrier layer 10 and active, highly absorbent layer 15 at different time intervals. Using the measurement results, it can be seen that a hydrophilicity and absorptivity gradient is created in the direction of the membrane.

TABLE

| | Time | | | | | | | |
|---|---|---|---|---|---|---|---|---|
| | After | | After | | After | | After | |
| | 30 sec | | 2 min | | 5 min | | 10 min | |
| Lining (5) | 10 | mm | 30 | mm | 50 | mm | 60 | mm |
| Hydrophilic barrier | 20 | mm | 50 | mm | 70 | mm | 90 | mm |
| layer (10) | | | | | | | | |
| Active, highly | 40 | mm | 80 | mm | 110 | mm | 140 | mm |
| absorbent layer (15) | | | | | | | | |

1. A composite material for application in a shoe upper, sole or seat cover, comprising a waterproof, water vapor-permeable functional layer as well as an air-permeable dual-layer composite,
wherein in that the dual-layer composite is constructed so that a layer of the dual-layer composite facing the functional layer has a higher hydrophilicity and absorptivity than a layer of the dual-layer composite facing away from the functional layer.

2. The composite material according to claim 1, wherein the hydrophilicity and absorptivity increase successively in the direction of the functional layer.

3. The composite material according to claim 1, wherein both layers of the dual-layer composite are selected from the group consisting of non-woven fabrics, knitted fabrics, woven fabrics, and combinations thereof.

4. The composite material according to claim 1, wherein the dual-layer composite is constructed so that the layer of the dual-layer composite facing the functional layer is formed by a non-woven fabric made of finer fibers and the opposite layer of the dual-layer composite is formed by a non-woven fabric made of coarser fibers.

5. The composite material according to claim 1, wherein the dual-layer composite contains polyester as one of its materials and is constructed so that the layer of the dual-layer composite facing the functional layer is formed by a non-woven fabric with a lower proportion of polyester and the opposite layer of the dual-layer composite is formed by a non-woven fabric with a higher proportion of polyester.

6. The composite material according to claim 5, wherein the dual-layer composite contains polyamide as an additional material.

7. The composite material according to claim 1, wherein the individual layers are selected so that a hydrophilicity and absorptivity gradient is established that increases in the direction of the functional layer.

8. The composite material according to claim 1, wherein the functional layer is a film or membrane made of expanded polytetrafluoroethylene (ePTFE), polyether ester, polyether amide, polyether urethane, polyester and/or polyurethane.

9. The composite material according to claim 1, wherein the side of the functional layer facing away from the dual-layer composite is adjacent to a knitted fabric or knitted spacer fabric.

10. The composite material according to claim 1, wherein the side of the dual-layer composite facing away from the functional layer is adjacent to a lining

11. A seat cover containing a composite material according to claim 9.

12. An item of clothing, headpiece, gloves or an item of footwear containing a composite material according to claim 10.
